(19) United States
(12) Patent Application Publication
(10) Pub. No.: US 2005/0108039 A1
(43) Pub. Date: May 19, 2005

(54) Semiconductor intellectual property technology transfer method and system

(76) Inventors: Takeshi Kanamori, Kawasaki-shi (JP); Miyuki Ando, Yokohama-shi (JP); Tamami Miwa, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/951,623

(22) Filed: Sep. 29, 2004

(30) Foreign Application Priority Data
Sep. 30, 2003 (JP) 2003-340591

(51) Int. Cl. G06F 17/60

(52) U.S. Cl. 705/1

(57) ABSTRACT

A computer-based system and method to grant IP rights on a sub-divided portion of predetermined manufacturing process technology, including subdividing the predetermined manufacturing process technology. Subdividing includes separating an intangible asset from a plurality of process technology data units, dividing said plurality of process data units into at least one of a first process technology data unit and a second process technology data unit, and a first process IP data unit and a second process IP data unit. Embodiments of the invention further include granting IP rights to a third party that requests IP rights to at least one of the first process technology data unit and the first process IP data unit, but not an entirety of the predetermined manufacturing process technology.

### CROSS REFERENCE TO RELATED PATENT APPLICATION

The present patent application contains subject matter related to that disclosed in co-pending and commonly owned U.S. patent application Ser. No. 10/457,545 filed on Jun. 10, 2003 entitled “Software IP Providing System and Method, Software EP Obtaining Method, and IP Core Designing in Manufacturing Method”, the entire content of which being incorporated herein by reference. The present patent application also contains subject matter related to that disclosed in co-pending and commonly owned U.S. patent application Ser. No. 10/937,354 filed on Sep. 10, 2004, entitled “Computer-Implemented Intellectual Property Technology Transfer Method and System”, the entire content of which being incorporated herein by reference.

### BACKGROUND OF THE INVENTION

1. Field of the Invention

The present invention relates to systems, methods, computer program product and apparatuses for classifying and segmenting process technology, providing the resultant incrementalized process technology for purchase or license by potential customers, and providing supplemental services for assisting in transfer of process technology. More specifically, the present invention relates to transfer of Intellectual Property (IP) for semiconductor process technologies. The present application is based on Japanese priority document, Japanese Patent Application 2003-340591, filed in the JPO on Sep. 30, 2003, the entire contents of which being incorporated herein by reference.

2. Description of the Related Art

Generally, process technology such as a semiconductor manufacturing technology has grown more complex as the products themselves become more sophisticated. As a result, proven process technology has become more valuable as a source of competitive advantage in the global market place. Realizing the strategic importance of protecting process technology from imitators and leveraging process innovations, corporate and private entities have placed a greater emphasis on protecting IP concerning their process technology. Additionally, owners of such IP aim for more effective leverage of in-house research and development (R&D) and manufacturing and operations activities as additional revenue opportunities. Often, such leverage is realized by licensing process technology to other users. IP as described herein refers to, but is not limited to, knowledge-based assets including trade secrets, RTL code, patents, copyrights, trademarks, manufacturing technology information (including, but not limited to, recipes), and methods of conducting business, especially as they relate to semiconductor manufacturing.

Conventionally, an entity (herein, a “licensor”) possessing a proprietary manufacturing process technology (e.g., Toshiba's 0.25 micrometer CMOS process technology) is approached by potential licensees that have become aware of the licensor's process technologies and express an interest in licensing these technologies. Licensors are sometimes known to approach licensees, including cases where a small entity having its own IP but lacking manufacturing capacity or production know-how approaches a larger entity. In some cases, a licensee and a licensor will enter into licensing negotiations, where the terms of a license for process technology, including the magnitude and frequency of royalty payments, are determined.

However, as recognized by the present inventors, the conventional technology transfer method often leads to a mismatch of the “product” (e.g., process technology) and “market” (potential licensees) in terms of cost and effectiveness. Moreover, the unknown transaction costs involved in conventional licensing negotiations are a deterrent or a significant hurdle for the successful and mutually beneficial transfer of process technology between licensor and licensee. Furthermore, there is often a mismatch in the specific needs of the licensee (perhaps having difficulty with a new wiring technology) and a licensor that does not have the licensing resources to craft a specific license agreement for this relatively niche technology request.

FIG. 1 is an exemplary illustration of a conventional process technology transfer process. A minor (in terms of financial resources and/or its own process IP capabilities) potential licensee 101 is represented as a small group of IP blocks, each of which representing know-how and/or assets associated with a process. A major potential licensee 103 is represented by a larger group of IP blocks. Both the minor potential licensee 101 and major potential licensee 103 approach a potential licensor 107 that possesses the rights to, or unique knowledge of, several full process technologies 105. While not strict categories, the terms “minor” and “major” with respect to potential licensees refers to a variety of differing characteristics such as process IP assets, customer base, employees, revenue, production capacity, existing process technology level or quantity, and willingness to license. Moreover, potential licensees 101, 103 possess their own process IP within which certain capabilities are absent 111 (shown as a missing block), underperforming 113 (shown as a dark block), or otherwise performing undesirably 109 (shown as a striped block).

The potential licensor 107 offers manufacturing process technology only in terms of full manufacturing process technologies 105. The full processes 105 are represented as large homogenous blocks. The licensor is reluctant to offer licenses covering only particular aspects of a full process for a variety of reasons including the complexities and resulting difficulties related to controlling a licensee's access to only a part of the full process, maintaining support for the process for an indefinite period of time, the relatively low return on effort for crafting a custom agreement for a small cost item. Furthermore, it is conventional for the licensor to view the process as a homogenous process (e.g., Company X's CMOS process), that is not suitable for parsing.

The complexity of the manufacturing processes, often hundreds of steps and involving temperatures, materials, substances, the amounts of use of the substances, etc., is yet another reason why companies are reluctant to license only portions of a complete process. It is conventional to consider these detailed process steps and conditions as know- how of the manufacturer, and integrally related to a much larger, inseparable process. Thus, manufacturers conventionally have not considered licensing parts of semiconductor process technologies to another manufacturer because it has been next to impossible to precisely specify numerous conditions for every manufacturer's equipment.

By offering process technology only in terms of full processes 105, the present inventors recognized that the licensor 107 may be missing a licensing opportunity with the minor potential licensee 101b, which is unable to or unwilling to license rights to the entire process technology 105 because it needs only a certain subset of the full process for its own operations and does not have the means, or interest, to license the entire process 105.

FIG. 1 also illustrates a case where the major licensee 103b acquires the IP rights to an entire process 105 for incorporation into it process technology despite the fact that the newly acquired process technology overlaps with its existing technologies 105b that operate satisfactorily. In this case, licensing an entire process results in unneeded costs to the licensee 105b in terms of licensing unneeded technologies.

As an example, in the semiconductor manufacturing industry, a potential licensee may only have need for dry etching technology for copper metal interconnects. In the conventional transfer, the potential licensee would be required to license technology for an entire process of manufacturing semiconductors using metal interconnects from a licensor, in which case the potential licensee would be paying for substantially more technology than is required or desired.

Moreover, a case may exist where a potential licensee lacks the financial resources or know-how to integrate a full process technology 105c into its existing operations. As a result, the licensing fees paid for this full process technology that would be underutilized and the full benefits of the newly acquired full process technology are unable to be realized.

As recognized by the present inventors, a limitation with the conventional transfer approach is that it is the licensor that sets of the terms of the scope of what process components are available for licensing. Thus, the licensee is left with a choice of either accepting the “bundle of sticks” offered by the licensor, or find another solution.

While not illustrated explicitly, a situation can also exist where a major potential licensee, anticipating the unnecessary costs or additional cost of integration involved in acquiring and making use of a licensed full process technology, chooses not to pursue licensing negotiations with the licensor 107 and instead invests financial and human resources (which can be in excess of the licensing fees) to develop improvements to their in-house process technology. Circumstances such as the examples described above would represent a lost opportunity for the licensor to leverage its process IP for additional revenue.

As recognized by the present inventors, the conventional method of transferring process technology is also disadvantageous because of unknown transaction costs directly associated with, or perceived in, conventional licensing negotiation. First, by not having specific information regarding a process technology available for licensing readily available to potential licensees, inefficiencies related to asymmetric information are created. For instance, a potential licensor may be missing out on existing market demand because potential licensees lack sufficient information on the process technologies available for license to warrant the initiation of licensing negotiations. In addition, since conventional licensing negotiations tend to be complex, nebulous processes are involved, potential licensees are sometimes deterred from entering into negotiations with a process technology licensor because of a perception of high transaction costs even if the real transaction costs are lower than those believed by the potential licensees.

Moreover, the conventional licensing negotiation process often also creates additional exposure of a potential licensee to the threat of litigation. In particular, in the course of negotiations, a licensor may become aware of a potential licensee's need or desire to acquire certain process technologies. Consequently, if the potential licensee breaks off negotiations but subsequently appears to have improved performance characteristics (such as decreased reported inventory levels, yield rates, cost of goods sold (COGS), etc.), the licensor might have reason to believe that the potential licensee is infringing on protected process technology.

Thus, the conventional transfer of process technology includes inherent inefficiencies for both potential licensees and licensors of IP rights for process technology.

### SUMMARY OF THE INVENTION

The present invention, only a brief summary of selected aspects of which are provided in this section, is intended to address the above-identified and other limitations with conventional process technology transfer, as well as efficiency and integration limitations of conventional process technology licensing systems and methods.

A first aspect of the present invention provides a computer-implemented method for granting IP rights on a sub-divided portion of predetermined manufacturing process technology, including subdividing the predetermined manufacturing process technology. Subdividing includes separating an intangible asset from a plurality of process technology data units, dividing said plurality of process data units into at least one of a first process technology data unit and a second process technology data unit, and a first process IP data unit and a second process IP data unit. The method further includes granting IP rights to a third party that requests IP rights to at least one of the first process technology data unit and the first process IP data unit, but not an entirety of the predetermined manufacturing process technology.

Alternatively, a second aspect of the present invention provides a computer-implemented system for transferring IP rights to a sub-divided portion of a predetermined manufacturing process technology including a first electronic archive and a second electronic archive. The first electronic archive is configured to hold therein a first process technology data unit and a second process technology data unit, and a first process IP data unit and a second process IP data unit. The second electronic archive is configured to hold therein a customer identification data that is retrieved when a third party attempts to access the first electronic archive. The customer identification data includes identification data and an indication of access rights obtained by the third party for granting access to the first electronic archive. The system further includes a management service supplier mechanism configured to serve web pages to a computer of the third party, the web pages including an access and verification web page that permits access to the third party if data is entered that matches the customer identification data held in the second electronic archive, and a process IP web page that presents for selection at least a subset of the first process technology data unit and second process technology data unit, and the first process IP data unit and the second process IP data unit. Additionally, the system includes a data delivery mechanism that is configured to send over a digital communication link to the third party the sub-divided portion of the predetermined manufacturing process technology selected by the third party.

Moreover, a third aspect of the present invention provides a computer-implemented system for receiving IP rights to a sub-divided portion of a predetermined manufacturing process technology includes a network interface configured to exchange digital messages with a management service supplier computer over a network, a browser configured to display web pages served by the management service supplier computer, an input mechanism configured for a user to enter customer identification data and select items presented on the web pages, and a processor configured to execute computer readable instructions that implement a messaging mechanism configured to insert the customer identification data into fields presented in the web pages so as to enable the user to gain access to a first electronic archive of the management service supplier computer. The first electronic archive is configured to hold therein a first process technology data unit and a second process technology data unit, and a first process IP data unit and a second process IP data unit. Additionally, the management service supplier computer includes a second electronic archive configured to hold therein the customer identification data that is retrieved when the messaging mechanism sends a digital message that includes the customer identification data. Moreover, the system includes a management service supplier mechanism configured to serve web pages to a computer of the third party, the web pages including an access and verification web page that permits access to the customer identification data included in the digital message matches the customer identification data held in the second electronic archive, and a process IP web page that presents for selection on the browser at least a subset of the first process technology data unit and second process technology data unit, and the first process IP data unit and the second process IP data unit.

Also, a fourth aspect of the present invention includes a computer program product containing computer readable instructions for execution on a computer-implemented system for transferring IP rights to a sub-divided portion of a predetermined manufacturing process technology including means for subdividing the predetermined manufacturing process technology. The means for subdividing includes means for separating an intangible asset from a plurality of process technology data units within the predetermined manufacturing process technology, and means for dividing the plurality of process technology data units into at least one of a first process technology data unit and a second process technology data unit, and a first process IP data unit and a second process IP data unit. The computer program product further includes means for conveying IP rights to a third party that requests IP rights to at least one of the first process technology data unit and the first process IP data unit, but not an entirety of the predetermined manufacturing process technology.

A fifth aspect of the present invention provides a computer-implemented method for selling IP on a sub-divided portion of predetermined manufacturing process technology, where the method includes subdividing the predetermined manufacturing process technology. Subdividing includes separating an intangible asset from a plurality of process technology data units, dividing the plurality of process data units into at least one of a first process technology data unit and a second process technology data unit, and a first process IP data unit and a second process IP data unit. The method further includes selling IP to a third party that requests IP to at least one of the first process technology data unit and the first process EP data unit, but not an entirety of the predetermined manufacturing process technology.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a conventional method of transferring process technology;

FIG. 2A is a process diagram describing an embodiment of the present invention;

FIG. 2B is a diagram illustrating how predetermined Process IP components may be arranged for selection;

FIG. 3A is a flowchart describing a process performed according to the present invention;

FIG. 3B is a block diagram of an exemplary system according to an embodiment of the present invention;

FIG. 4A is a diagram illustrating an exemplary classification by process hierarchy according to the present invention;

FIG. 4B is a diagram illustration exemplary technology parameters for a Process Module according to the present invention;

FIG. 4C is a diagram of an alternative example of technology parameters for a Process Module Set according to the present invention;

FIG. 5A is an exemplary database structure showing stored categories of technology information parameters and associated components;

FIG. 5B is a diagram showing an example of how assets may be supplemented according to incremental license as provided by an embodiment of the present invention;

FIG. 6 is a flowchart of an interaction between a licensor and licensee as provided by an embodiment of the present invention;

FIG. 7 is a flowchart of how delivery of Process IPs may be accomplished by physical data medium;

FIG. 8 is an exemplary flowchart describing a process through which a potential licensee can receive advisory services from a Process IP owner;

FIG. 9 is an exemplary flowchart of supplemental educational services provided by a licensor;

FIG. 10 is an exemplary flowchart of integration consulting services provided by a licensor; and

FIG. 11 is block diagram of a computer system upon which an embodiment of the present invention may be implemented.

### DETAILED DESCRIPTION OF THE PREFERRED EMBODIMENTS

Embodiments of the present invention addresses the above identified and other limitations with conventional process transfer operations. In particular, embodiments of the present invention provides a system and method to partition and classify process technology, offer and provide access to that partitioned and classified process technology, license selected portions of the technology according to selections made by a licensee, and also, optionally, offer integration and education services.

The present inventors recognized that a complete process technology is able to be partitioned and classified in terms of process hierarchy. More specifically, process hierarchy involves the division of full process technologies (e.g., Toshiba's 0.25 micrometer CMOS process) into Module Sets (e.g., front end and back end module sets), which are in turn divided into Process Modules (e.g., gate contact processes, metallization processes, etc.), and Process Modules are, in turn divided into Unit Processes (e.g., chemical vapor deposition, dry etching, etc.).

In addition, partitioning and classification of process technologies is also performed according to parameters such as technology information. In the semiconductor industry, examples of technology information include, but are not limited to, clean room facility, test vehicle, design, process, equipment, material, device, and quality and reliability information. Moreover, the present invention also partitions, classifies, and associates know-how, or supplemental information, with the partitioned and classified process technologies and customer's existing technology.

Herein, the term “Process IP” is used to describe any and all subsets (which includes combination of subsets) of portions of process technology that can be made substantially independent from each other from technology and manufacturing integration standpoints. Other examples of Process IP include, but are not limited to, RTL code, intellectual property rights to a patent, a claim within a patent, and a predetermined scope of intellectual property rights to a patent or claim. Know-how related to intellectual property contained within the meaning of Process IP. Complementary information includes details about a Process IP or several Process IPs pertinent to the integration, usage, and maintenance of the corresponding Process IPs. Optionally, complementary information also relates to the integration of a Process IP into a licensee's existing activities and process technology.

As described above, by “compartmentalizing” or dividing a process technology into various levels of Process IP units, a licensee is able to purchase or license only those specific units or aspects of process technology that are required or desired to work complimentarily with process technology already possessed by the licensee. This approach encourages cost saving for all parties by enabling the purchase or part of a process, instead of purchasing a complete set of process technology. Moreover, it may reduce the cost of technological development and the risk of acceptance by either management or the market of new technology as the reliability and effectiveness of Process IP can be proven by the activities of support of the licensor. Furthermore, by using Process IP, a licensee may enter a new market more easily or enhance activities in a market in which they already have a presence by diverting focus from new research and development to design, strategy, and marketing.

As suggested above, the Process IP can be used in several different circumstances and activities. For example, in the area of semiconductor manufacturing, the Process IP can be used to start a new foundry for MOS logic products, solving a problem of finding a source for new technology. In addition Process IP can be integrated into existing activities in manufacturing MOS logic products, thus solving a budgetary restriction that would prevent the company from buying the rights to use an entire process. Process IP can also be used for an existing semiconductor manufacturer to convert from bipolar/GaAs product manufacturing to MOS logic by selecting only those processes that are missing for such a conversion in production technology. Moreover, if a semiconductor manufacturer wants to, for instance, use a new material, move to a larger wafer size, use new equipment, improve yield rates for the existing process, or move whole sale to a new, advances process, Process IP can be used to achieve such goals.

An additional aspect of the present invention provides a system and method for offering and providing Process EPs to a market that includes potential licensees. This aspect can incorporate multi-level permission interfaces for viewing, selecting, and purchasing Process IPs. In addition, pre-license advisory services to assist a potential licensee in selecting the required and most effective Process IPs for customer stated goals can be provided automatically using a system which matches a “wish list” or a customer profile with available Process IPs or using a group of experts, such as engineers of the licensor to process an advisory service request from a potential licensee. These advisory services can also present an additional source of revenue for a licensor. In addition, purchased Process IPs can be made available online for download or via a physical data media such as a CD or a DVD, or on paper.

Another aspect of the present invention includes static or dynamic licensing of rights to individual and groups of Process IPs. In the static case, licenses are pre-drafted for each Process IP and sent to a potential licensee for approval before purchase. In the dynamic model, license terms such as royalty payments, term, unit limits, and exclusivity, are created according to parameters such as a customer or potential licensee's profile (including, but not limited, company size, financial condition, and usage), the particular Process IP and its technology (value, type, versatility, usage), licensor needs and requirements (for instance, licensing terms driven by development costs incurred by the licensor for selected Process IPs), and any other factors that may effect the value of purchase Process IPs to either party in the transaction. Examples of rights include, but are not limited to rights to make, use, sell, have made, import, export, assign, or sub-license. Moreover, such usage can be limited according to time period, geography, exclusivity, and field of use.

The present invention also accomodates an embodiment in which licenses are created for each purchase order using licensing personnel of the licensor.

Moreover, in addition to the above activities, an embodiment of the present invention also incorporates services such as integration consulting and client education. Integration consulting can include providing additional know-how related to the integration of Process IPs with technologies already in use by the licensee more detailed and crucial to integration success than that disclosed initially to a potential licensee. For example, this know-how can include access to case studies and other documents published by, for example, the licensor. In addition, integration consulting services can be free or for pay. One embodiment of the present invention includes free integration consulting services for a limited period of time after purchase, and additional services provided at a cost determined by a contract between the licensor and licensee. In addition, the system also provides education for the licensee, which includes online courses, custom classes on the premises of the licensee, and seminars.

Such “a la carte” provisions for delivering know-how and services enables licensees to translate formerly fixed costs associated with licensing process technology into variable costs that can be reduced according to need. For instance, if a small entity licensee is able to quickly integrate newly acquired Process IPs into its existing activities without assistance, the present invention enables the small entity licensee to purchase only the Process IPs and eliminate the purchase of know-how and services that are not needed, or redundant.

Furthermore, an additional aspect of the present invention is that it provides a flexible, accessible, and efficient platform for the transfer of process technology. As described above in relation to the prior art, process technology transfer in its conventional form typically entails a significant investment in time and financial resources because process technology is conventionally transferred as entire processes. As a result, such a conventional transfer creates problems utilizing the newly acquired technology with existing technology already in possession of the licensee due to issues such as compatibility with existing equipment. Moreover, by offering licenses for only entire processes, a potential licensee could be placed in a situation of having to purchase an entire process where only a certain subset of that process is required. Alternatively, a licensor can be placed in a disadvantageous position of offering only entire processes to potential licensees desiring and willing to pay for only a subset of those processes. By dividing large processes into integral components, called unit processes, the present invention can more effectively provide for transfer of process technology between licensee and licensor.

Additionally, by separating process technology from know-how and additional services and thus making some costs variable that were conventionally fixed, both the licensee and licensor can further realize the cost-efficiency gains of incremental process technology transfer.

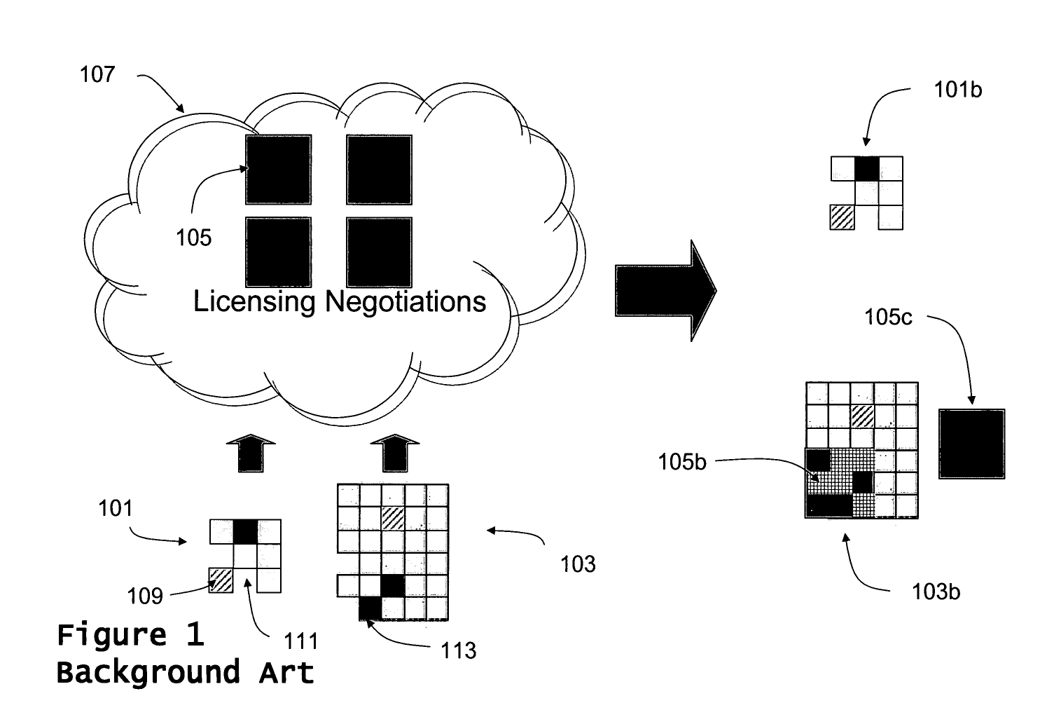

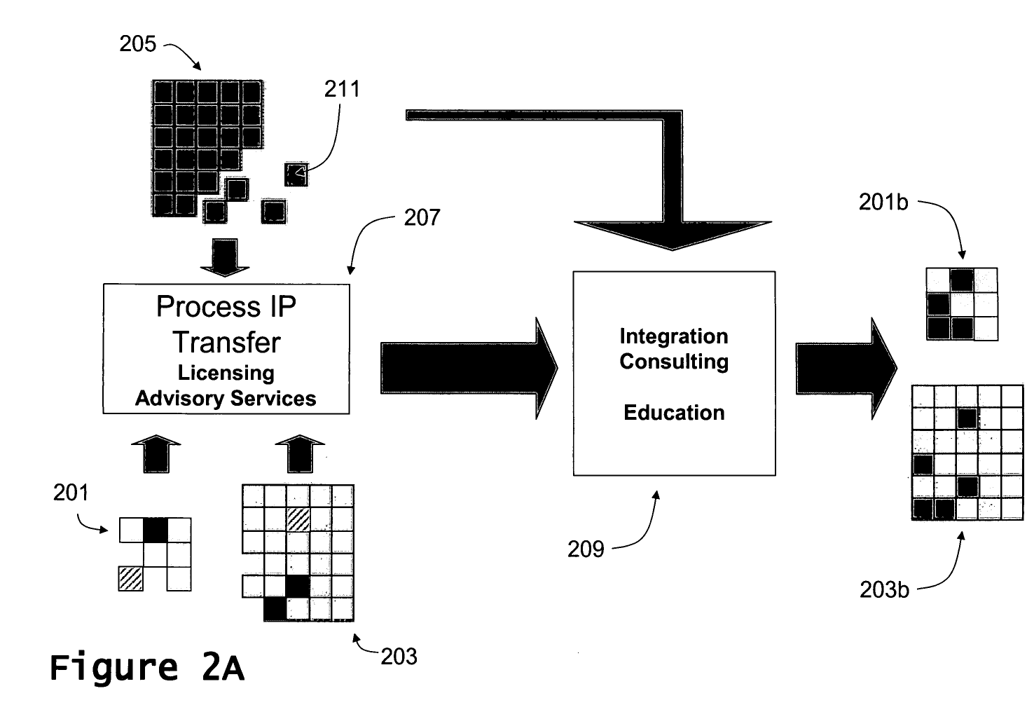

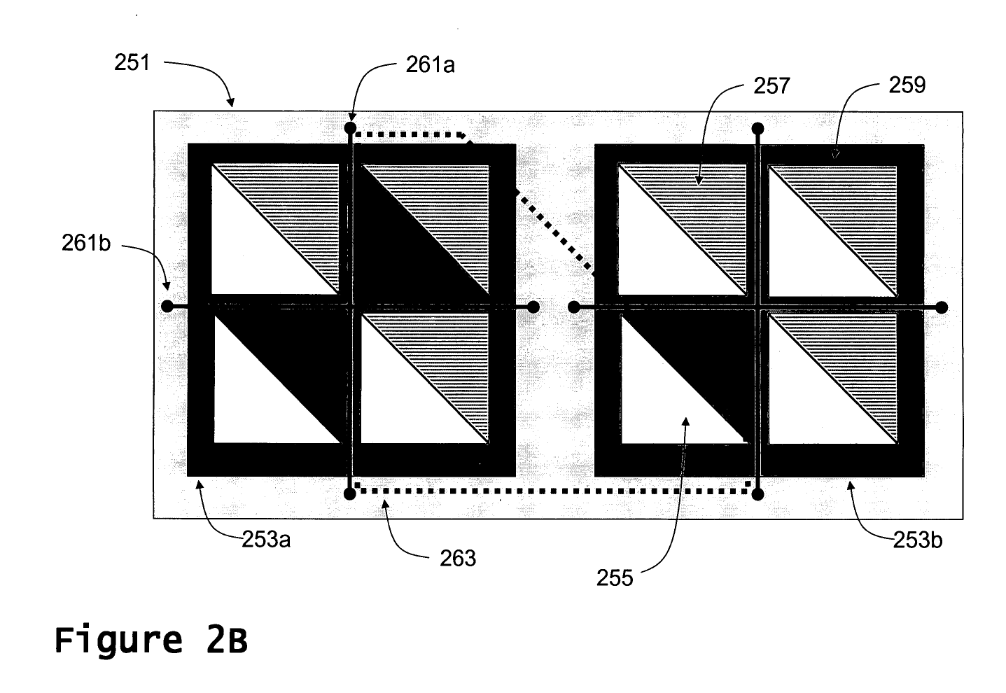

Referring now to the drawings, wherein like reference numerals designate identical or corresponding parts throughout the several views, FIG. 2A is an exemplary diagram describing an embodiment of the present invention. A small potential licensee 201 and a large potential licensee 203 (each having attributes like that described with regard to FIG. 1), and a licensor of Process IPs 205 engage in a Process IP transfer 207. The transfer includes static or dynamic licensing activities as described above and/or pre-license advisory services, also described above. In addition to transferring Process IPs under conditions determined by licenses, the licensor 205 can also provide additional services 209 including integration consulting and education (such as seminars) for quicker and more efficient integration of Process IPs into the licensees' existing activities. As a result, regardless of size or degree of need, small licensees 201b and large licensees 203b are able to obtain only those portions of process technology (211) that are desired or required and integrate them into their existing activities.

FIG. 2A illustrates that the licensor offers candidate portions, or units, of process technologies for selection by licensees 201 and 203. Thus, it is the licensees who select what portions 211 of the full process 205 they wish to obtain by way of license (or even possibly assignment or sale). In the process IP transfer 207, the licensees select from a menu of candidate process IPs from which they may browse. In one embodiment, the process IP transfer 207 is performed by the licensor using a web server to server web pages to the licensees 201 and 203, so the licensees may browse through the available process EPs, as well as the terms and conditions associated with the licenses so they can make an informed selection prior to executing a pre-formatted license which is also made available for execution by the browser used by the licensees. Alternatively, once the process IPs are identified by the licensees the licensees can request that paper documents be sent to them for review and execution.

Because the identification and selection of various process EPs can be complex, the licensor optionally offers (for a fee, or optionally as a free service) technical assistance by way of the integration consulting and education service 209. The integration consulting and education service 209 includes an on-line help section, which provides data regarding the various IPs, as well as a compatibility chart showing which process IPs are known to be compatible with other process IPs. Furthermore, the integration consulting and education service 209 offers on-line, voice and in-person consulting services to aid in the selection of appropriate process IPs.

FIG. 2B is an exemplary diagram illustrating how a potential licensee can select various process technology components, a “predetermined process technology” 263, from a superset of available process technologies 251. For example, a large licensee may possess IP rights to multiple Full Process technologies 253a, 253b. According to one aspect of the exemplified embodiment, the Full Processes contain multiple Process Technology Data Units 259. These Process Technology Data Units may include a Process IP 255, complementary information 257, or both. Although not shown explicitly, the Process Technology Data Units can also include components with other hierarchical parameters such as a Process Module Set, a Process Module, or Unit Process. Hierarchical parameters are discussed in more detail below.

In FIG. 2B, the division and classification of information contained within a Full Process is accomplished through the use of two dividing parameters, a hierarchical parameter 261a, and a technology information parameter 261b. Further description and examples of these parameters are discussed below. By providing access to components within complete process technologies, the present invention enables the selection of such components. In this example, a licensee selects a user-selected set of process IP 263 (shown in dashed lines) that includes Process IPs and complementary information from two different complete process technologies (253a and 253b). Again, although not shown explicitly, the user-selected process technology 263 can also contain components from more than one Process Module Set, Process Module, or Unit Process.

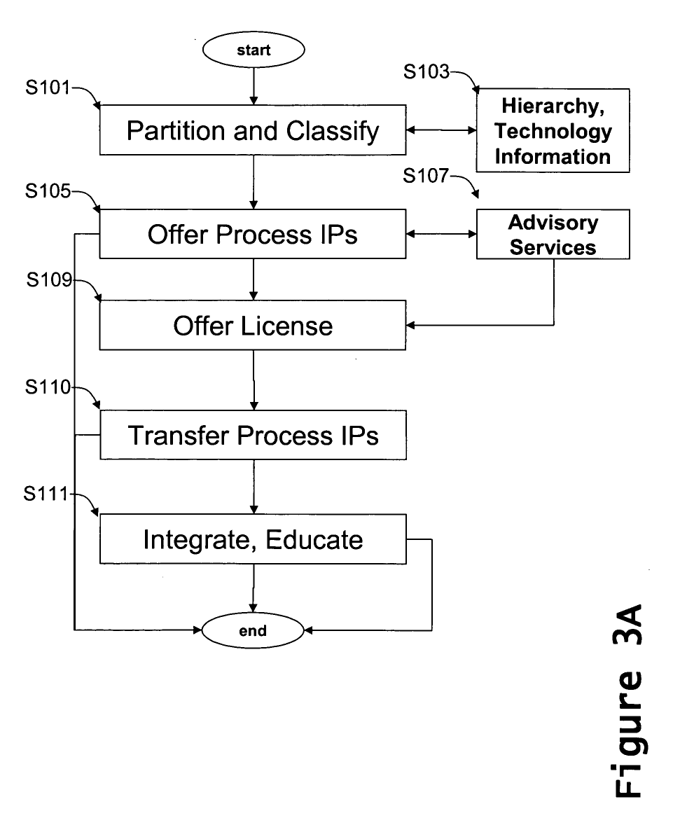

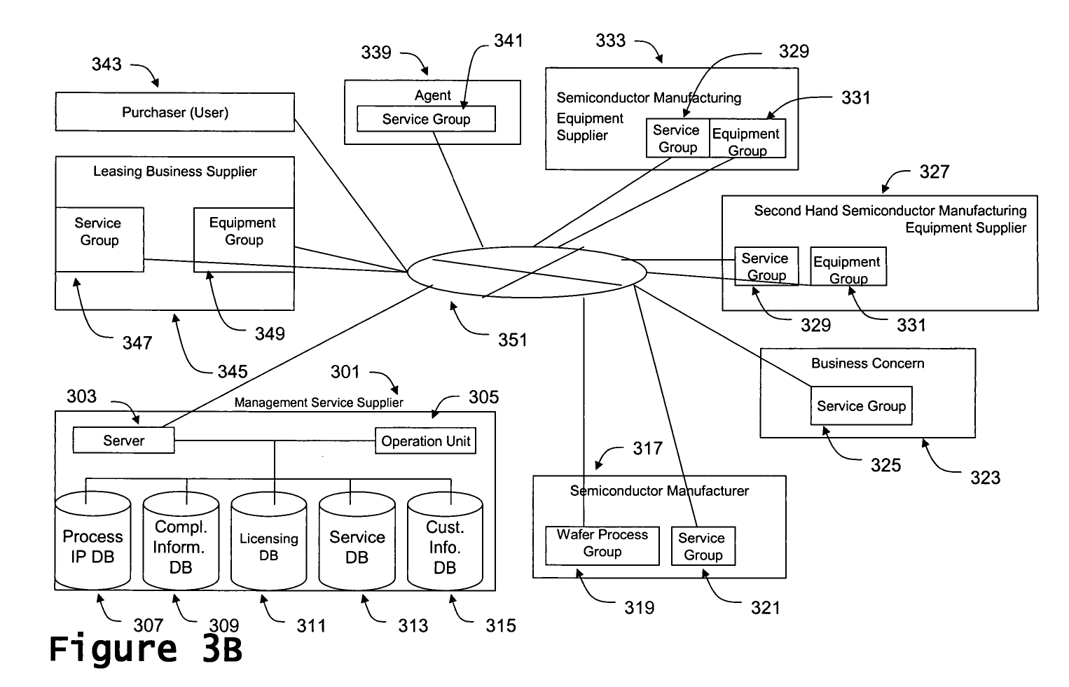

FIG. 3A is a flowchart describing functional aspects of the present invention. Beginning with full process technologies, the system partitions (e.g., manually partitions and saves the partition attributes in memory for subsequent retrieval) and classifies these sub-portions of the full process technologies in step S 101 using a process hierarchy and/or technology information input in step S103 (as represented in FIG. 2B). Alternatively, the system automatically partitions the process technologies of a second process technology based on divisions made for a first process technology. Next, the resultant process IPs are offered for viewing, selecting, and licensing or purchasing by potential licensees S105 by way of the licensee selecting the process IPs of interest to the licensee by browsing on a web site hosted by the licensor (or agent of the licensor).

Optionally, a potential licensee can request advisory services on selecting Process IPs according to a described need or goal S107. These advisory services can either be direct contact with technical/legal support from the licensor, or documentation (on-line, or printed).

Then, a license for the selected process IPs is created either statically (i.e., a preformatted license retrieved from memory) or dynamically (a preformatted license that requires customization from the licensee and the licensor by way of interactive negotiation, in person or virtually over the Internet). Once created, the license is offered in step S109, and upon agreement to the license terms the license is executed. Once executed the process EPs are transferred to the licensees S110 (a set of documents and/or code delivered electronically or in tangible format), as well as additional supplemental information or know-how if such information is included in the purchased process IP. Optionally, a licensee can then request integration consulting services and education regarding the purchased Process IPs S111.

Further, in either static or dynamic license creation embodiments, licenses may include a variety of limitations. For example, licenses granted using an embodiment of the present invention include, but are not limited to, any one or more of the following parameters: a right to make and/or use; a have made right; a right to sell; a right to export; and a right to import. Such parameters can also involve time, expiration, and exclusivity. Moreover, additional embodiments of the invention provide for parameters granting or limiting access to RTL code within a license agreement or sale from a process IP owner.

One example of using process IPs to enhance a current business's production process includes production technology and yield management IP for the semiconductor manufacturing industry. The system according to the present invention makes available to potential licensees various information required for manufacturing line construction of wafer process (silicon process), such as equipment specifications, process information, test information, etc. Examples of yield management IP include special test chips for identifying defects, thus shortening the setup period for a production line sharply. As designs shrink and become more complex, process control solutions and yield management have gained more importance. Discovering problems in yield rate and taking necessary actions for efficient Large Scale Integration (LSI) manufacturing line setup are valuable.

However, in multi-product production in system LSI, specifying problems is typically difficult. An additional example of Process IP technology includes clean room and facility technologies. Clean systems of manufacturing are more important than ever as circuits become more integrated and wafer sizes become larger. Clean room management helps to improve quality of products and the productivity rate (yield). Process IPs for clean room technology applicable to various circuit sizes and wafer sizes are provided, including recently developed micro-environment technology.

FIG. 3B is an exemplary embodiment of a system that provides access to subdivided portions of process technologies, including Process IPs, for licensing to a wide market of potential licensees. The system includes a management service supplier 301, which contains a server 303 (which can operate as a web site server that communicates with a user computer 343) and operation unit 305 functionally connected to a Process IP database 307, a complementary information database 309, customer management database 311, an alliance database 313, and a program database 315. In the examples illustrated herein, a management service supplier 301 is an example of a licensor of process technologies. The management service supplier 301 need not include the inventive entity of the process technology, nor be the owner of such technology. For instance, a large manufacturing entity may set up an independent subsidiary to manage its process technology and provide access to Process IPs to licensees. Alternatively, a separate corporation could manage and provide process technology for the actual owners of process technology.

The operation unit 305 contains code for programming the server 303 to implement verification and authentication services for allowing only authorized users access to the process IP database 307. It also enables the server 303 create a virtual forum that “lays open” the candidate process IP available for licensing over the web. The complementary information database 309 contains information that is related to a particular process IP, but is not a technological component of it. For example, a particular process EP may be all RTL code, while the complementary information in the database 309 includes related information such as yield management information that assist in maintaining good yields for parts that are manufactured using the process IP.

The licensing database 311 includes predetermined draft licenses and already executed licenses for different customers. The service database 313 includes a record of service contracts and service data for each process IP to which a license has been issued, as well as prospective terms and conditions to be proposed to a potential licensee upon inquiry by the licensee. The customer information database 315 includes, among other things, a unique identification for a particular customer (or an employee of the customer), and an associated password(s) to ensure an unauthorized user does not obtain unauthorized access to the information held in the management service supplier computer 301. The customer information database also includes history information regarding past transactions and a portfolio of rights already available to the user. This assists the operation unit 305 in recommending/excluding other process EP that may be compatitible/uncompatible with the process IP already selected.

Potential purchasers 343 of process IPs from the process IP database 307 often have arrangements with a semiconductor manufacturer 317 (e.g., a foundry) with a wafer process group 319 and service group 321 to assist the purchaser 343 in manufacturing the a desired product based on the process IP licensed from the Management Service Supplier 301. A miscellaneous business concern 323 with a service group 325 is also a potential partner of the purchaser 343, as the potential purchaser may request assistance from the service group 325 to offer design, or quality assurance services to help the purchaser 343.

Moreover, a semiconductor equipment supplier 333 with a service group 335 and equipment group 337, as well as a second hand semiconductor manufacturing equipment supplier 327 with its own service group 329 and equipment group 331 are also potential licensees, or may partner with the purchaser 343. Other examples of entities that may partner with the user 343 include an agent 339 with a service group 341, and a leasing business supplier 345 with a service group 347 and equipment group 349.

In one example, the purchaser 343 recognizes that the purchaser would like to obtain rights to a mature, proven semiconductor IP process. By way of the network 351 (e.g., the Internet), the purchaser logs onto the site hosted by the server 303 for identifying if the management service supplier 301 has the appropriate Process IP to solve the needs of the purchaser 343. To aide the purchaser 343 in making the assessment, the management service supplier 301 makes inquires to the purchaser to see if the purchaser 343 needs different types of assistance, such as for obtaining semiconductor manufacturing equipment, a foundry (317) or even advisors, such as by way of an agent 339 or through business suppliers 345.

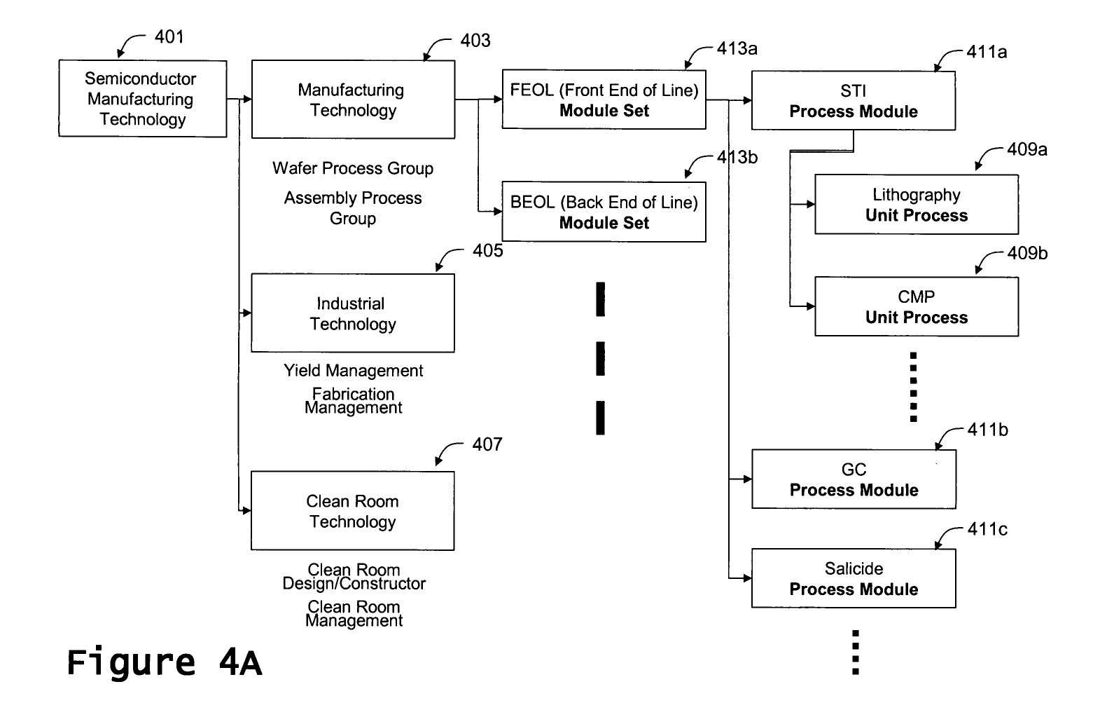

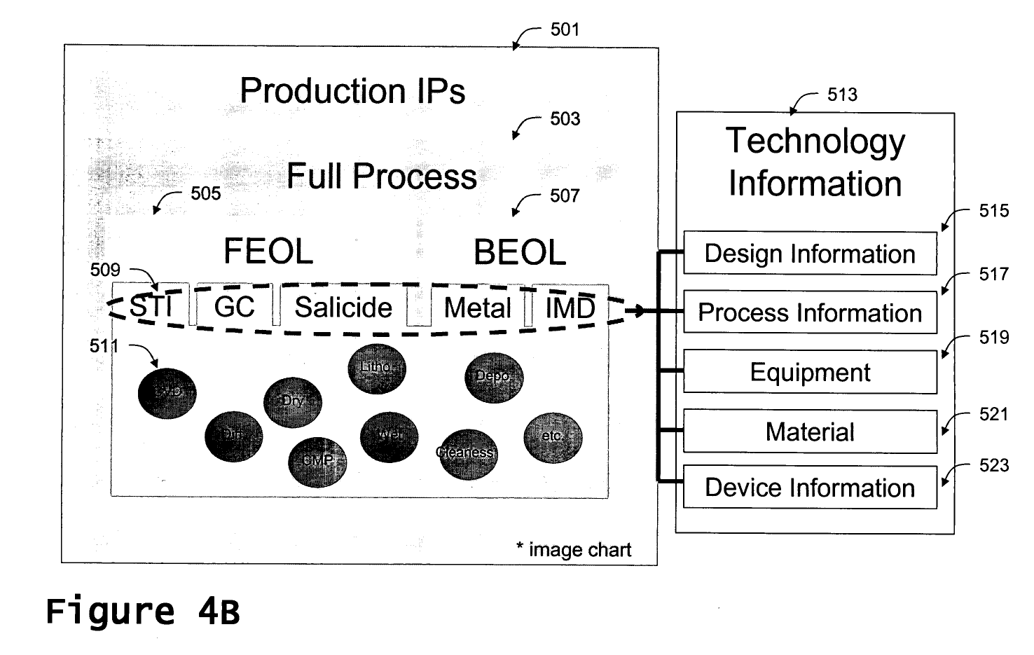

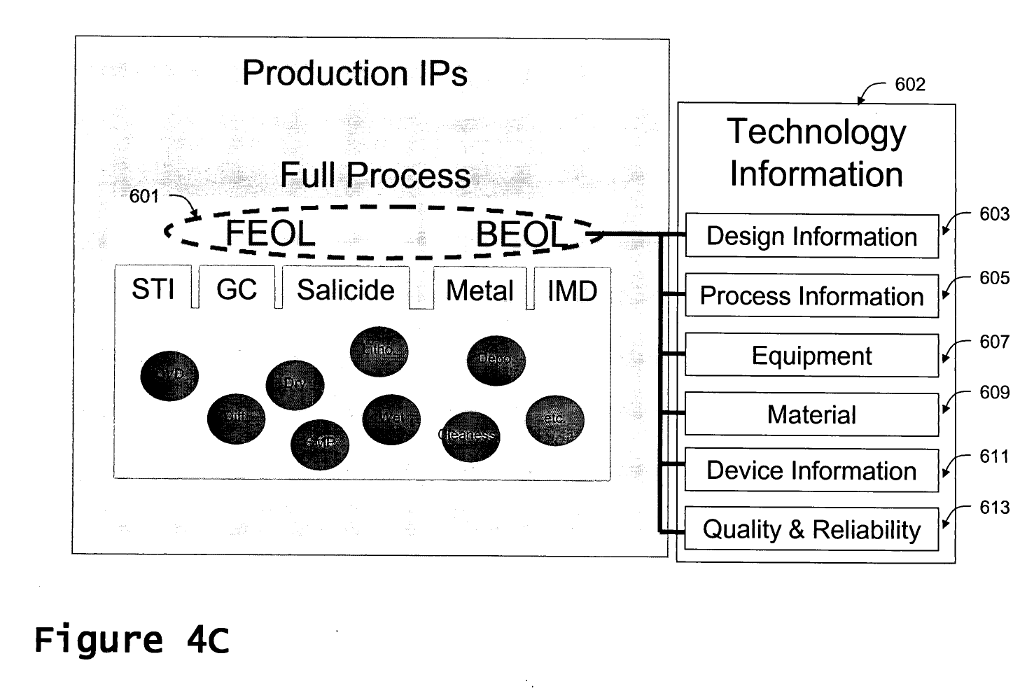

FIG. 4A shows an exemplary embodiment of how to classify portions of process technologies according to a process hierarchy according to the present invention, and can conveniently be understood when compared with the diagram of FIG. 4B. In the example of FIG. 4A, a semiconductor manufacturing process technology 401 is divided into manufacturing technology 403, industrial technology 405, and clean room technology 407 categories. In turn, the manufacturing technology 403 is further broken down into Module Sets 413 (front end of line processes 413a and back of the line processes 413b). The Module set 413a is further broken down into Process Modules 411 (411a, 412b, and 411c), which in turn are further broken down into constituent unit processes 409 (409a and 409b). Although not shown, the BEOL module set 413b is similarly broken down. With regard to the unit processes, these unit processes are not mutually exclusive. It is possible that some process modules require a common unit process (e.g., lithography 409a). In either case, the licensee has the option of selecting all unit process that are associated with a particular process module, or choose to opt out of selected unit processes.

Optionally, in another embodiment, the supplier 301 provides another service supplied by certain partners 317, 323, 327, 333, 339, 343 and/or 345 together. Further, the management service supplier 301 provides every service supplied by all partners 317, 323, 327, 333, 339, 343 and 345 with the process IP. Alternatively, a representative single partner 317, 323, 327, 333, 339, 343 or 345 may provide every service supplied by all partners.

FIG. 4B shows an additional representation of how the process technologies are divided and classified using a hierarchical parameter. For example, production IPs 501 include full processes 503, which in turn contain front end of the line (FEOL) 505 and back end of the line (BEOL) 507 Process Module Sets for a semiconductor manufacturing process. Contained within the FEOL Process IP 505 are various Process Modules such as shallow trench isolation (STI), gate contact (GC), and silicate processes. BEOL Process Modules 507 include metal and inter-metal dielectric (IMD) technology. Various Unit Processes fall under the above-mentioned categories, including chemical vapor deposition (CVD) 511, diffusion processes, dry etching, chemical mechanical polishing (CMP), lithography, wet etching, deposition, cleanness, and various other unit processes. The figure further shows exemplary technology information parameters 513 associated with (or complementary to) the actual process modules. One implementation is through a relational database that associates technology information entries with the different Process IPs so there is a linkage between the Process IPs and specific technology information associated therewith. These parameters include, but are not limited to design 515, process 517, equipment-specific 519, material-specific 521, and device-specific 523 information.

FIG. 4C is another example of technology information related to FEOL and BEOL Process Module Sets 601. FIG. 4C also illustrates other types of technology information parameters 602 that can be used to classify the Process IPs at the Process Module Set level, such as design 603, process 605, equipment 607, material 609, device 611, and quality and reliability information 613.

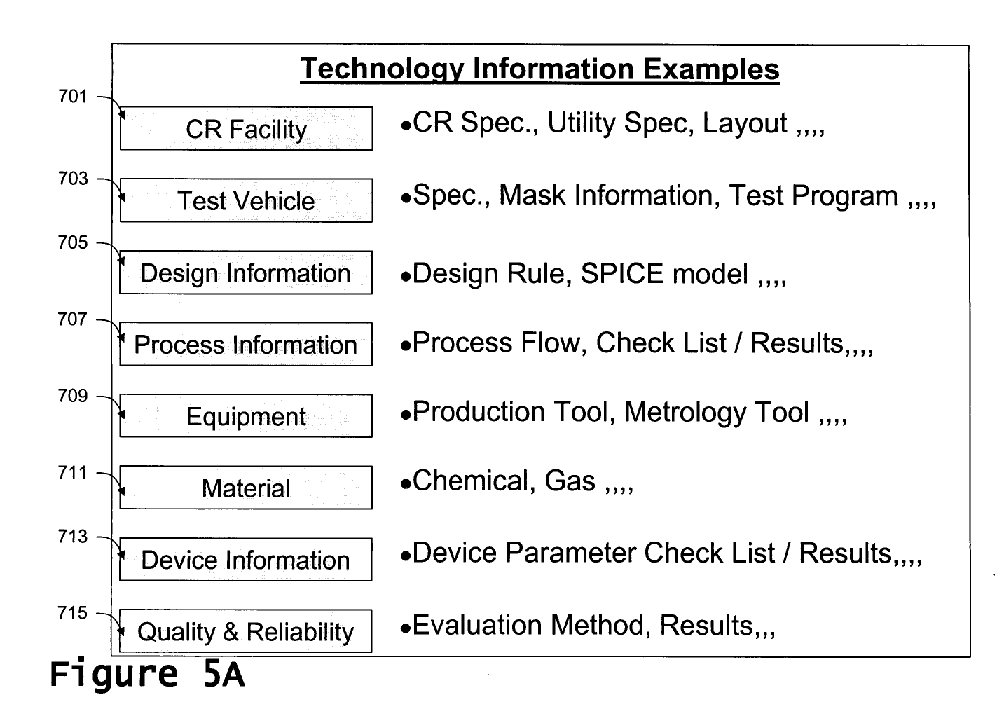

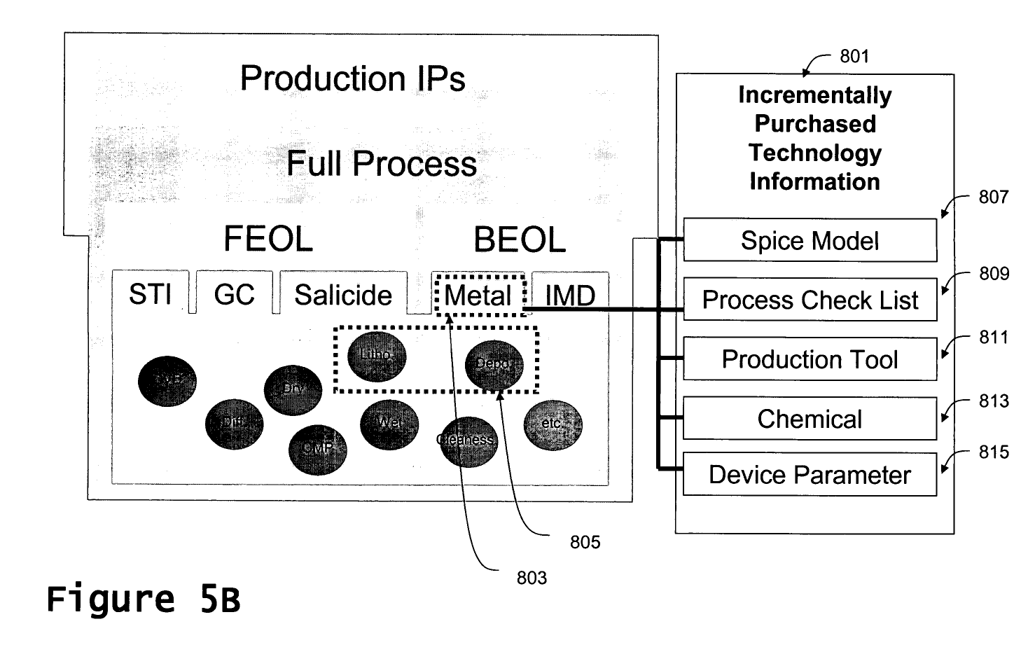

FIG. 5A shows a more expansive, but non-exhaustive, list of examples of technology information parameters, each of which may be stored in memory for retrieval in response to a command. The figure also shows several examples of technology information parameter components, such as a design rule or Simulation Program with Integrated Circuit Emphasis (SPICE) model with respect to design information 705. Example technology information examples include clean room (CR) facility information 701; test vehicle information 703; design information 705; process information 707; equipment 709; materials 711; device information 713; and quality and reliability 715, as shown.

FIG. 5B is an example of an incrementally purchased license of process IPs 801 made possible by an embodiment of the present invention. In the case depicted herein, a SPICE model 807, process check list 809, production tool 811, chemical 813, and device parameter 815 for lithography and deposition technologies 805 with relation to metal 803 BEOL activities are licensed. These incrementally purchased technology information may be purchased in discrete steps as the different process IPs 805 and 803, for example, are purchased. This method of incremental purchase enables to licensor to manage cash flow, and be in control over not having to take licenses to more Process IP than the licensee is able to handle at a time. This incremental approach allows a user to “make do” with perhaps suboptimal, although adequate existing Process IP that is available to the licensee so the licensee is able to manufacture product in fashion that is commensurate with the licensees ability to afford improved Process IPs.

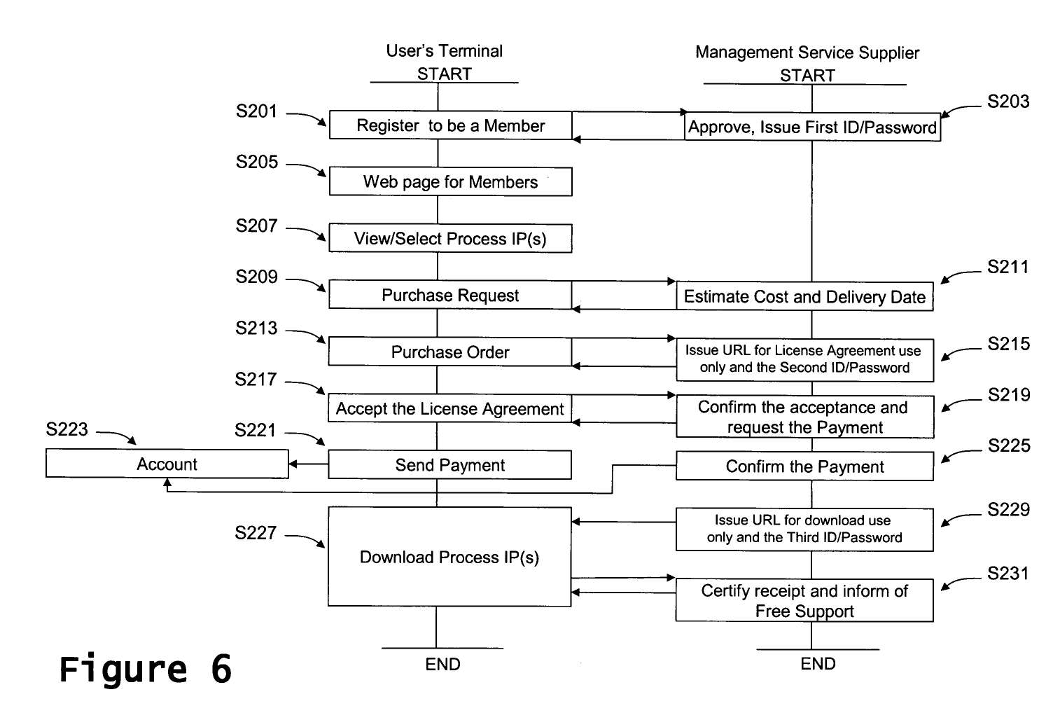

FIG. 6 is an exemplary flow chart describing an interaction between a licensee and a management service supplier as provided by an embodiment of the present invention. First, the user registers to be a member S201. The management service supplier then approves and issues a first ID and password to the user S203 for identification and secure access in future authentications. Using the first ID and password, the user then uses a browser to navigate to a web page for members S205, where the user can refer to a process IP list S207. In this web page for members, the user may will find a forum with other members (perhaps his partners) that will offer various equipment (e.g., second hand equipment identified as being compatible with process IP selected by the user) and services (e.g., consulting services) that may be needed by the user. This may be a nested list, where the user navigates through a series of hierarchically arranged web pages before arriving at the process IP of interest. Having looked at the list, the user can then request a Process IP for license or purchase S209. Optionally, as suggested in examples shown in FIGS. 2A and 2B, the user selects more than one Process IP for license or purchase. In a related example, the user's selection, shopping cart or “basket,” contains process IPs corresponding to unit processes corresponding to different process modules, module sets, and full processes.

Subsequently the management service supplier informs the user of an estimated cost and delivery date for the requested purchase S211. If the user is in agreement with the estimated cost and delivery date, the user then executes the purchase order S213 after which the management service supplier issues a URL for the license agreement along with a second ID and password S215, used for a second layer of security an controlled access to the license. As described above, the license agreement can be created dynamically, or provided from a static database. The user then accesses the license agreement at the supplied URL using the second ID and second password and accepts the license agreement S217. The management service supplier then confirms the acceptance of the license agreement and requests payment from the user S219. The user then submits a payment S221 to a bank S223, and this payment is confirmed by the management service supplier S225 before issuing a URL for download of the Process IP information in conjunction with a third ID and third password S229. The user then downloads the Process IP S227 and a certificate of receipt and notification of free support for a limited time is sent for the user from the management service supplier S231.

Alternatively, levels of support can be provided for free or for varying levels of cost. Additionally, such support can be provided by the management service supplier itself, or a partnered company such as a specialized consulting firm.

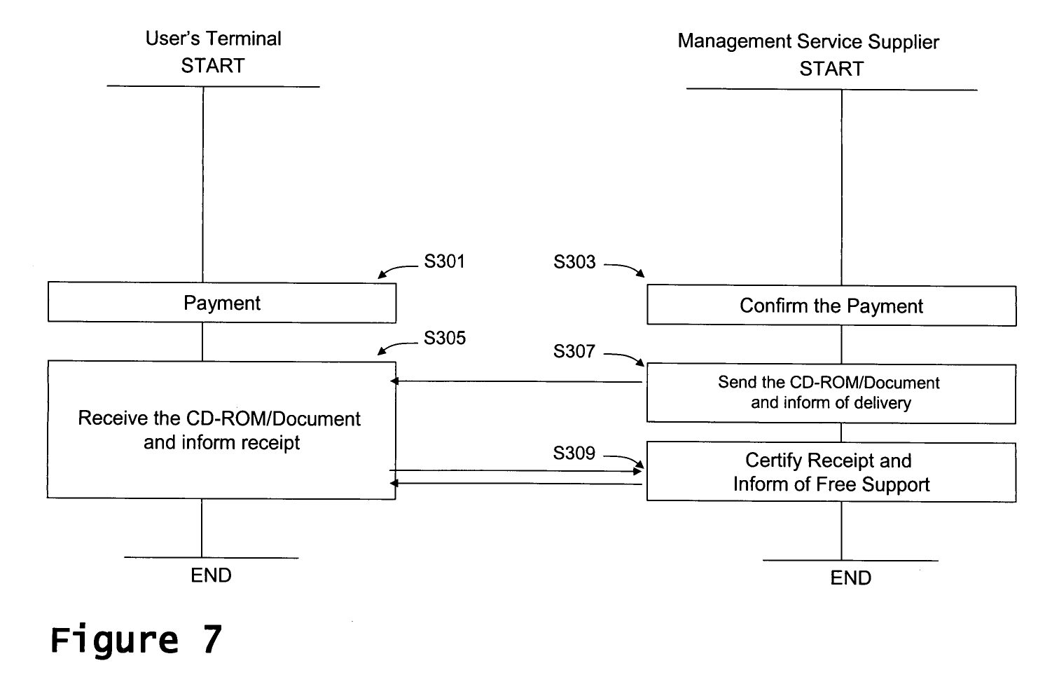

The present invention also provides for the delivery of process IP information to be achieved using a physical data medium such as a CD ROM, as depicted in FIG. 7. Upon the user's issuance of payment S301 and confirmation of the payment S303 by the management service supplier, a CD ROM or physical document containing process IP information is sent to the user S307, the user then confirming the receipt of the CD ROM or document S305. The management service supplier then sends the user a certificate of receipt and informs the user of free supports included with the purchase S309.

Optionally, by licensing a process IP, the user obtains a free support period of, for example, one month, as set forth in a certificate, which is issued at the end of the download session. If the process IP is received in a CD-ROM (as an example) the management service supplier notifies the user of a URL that a free service certificate has been issued to the user. The certificate states the proof of receipt and the predetermined free support period of, for example, one month.

During the free support period, the user can transmit inquiries, etc. on the received process IP, on a predetermined Web site hosted by the server 303 (FIG. 3B). In this regard, the management service supplier 301 provides support by replying to the user's inquiries through the network 351. Thereafter, the management service supplier notifies the user of the date of expiration over network 7 days, for example, before the expiration of the free support period. Further, the management service supplier 301 notifies the user when the expiration period has lapsed, at which point the technical support terminates, unless both parties execute a license extension to continue with the support service.

In the case where the technology is offered by sending the user the process IP in the form of a CD-ROM or a document, the management service supplier 301 transmits a message over the network, giving notice to the user about the expiration (or scheduled expiration) off support services. The message includes a receipt confirmation indication, which the user consents to, and the service provider is notified of the user having been informed of the termination of the free support service.

In a case where the technical support personnel offer a seminar for supplementary explanation or the like of any offered process IP, each user having purchased the process IP, is able to attend the seminar after being informed by the management service supplier 301 by way of the Internet, and upon submission of an application for attending the seminar. The application may be presented on a web site served by the server 303. Thereafter, the management service supplier holds the seminar on a predetermined Web site or in a hall or the like.

In the case of holding the seminar on the Web site, a button for confirming the attendance is displayed on the predetermined Web site after the seminar, and the attendance is ended when the user has pressed the button. Thereafter, the management service supplier 301 accepts inquiries on a predetermined Web site within a term of, for example, 2 weeks. The management service supplier 301 notifies the user of the expiration of the available question and answer term so that the seminar (including a question and answer term) may be completed.

In the case of holding the seminar in a predetermined hall, the management service supplier 301 receives an attendance report from each attendant after the seminar. The management service supplier 301 uploads the attendance report into a server for storing user information therein, whereby the user is permitted to confirm the attendance report. Thereafter, the management service supplier 301 accepts inquiries on a predetermined Web site within a term of, for example, 2 weeks after the seminar so it may answer any questions posed by the attendees. The management service supplier notifies the expiration of the term to the attendant at the expiration of the inquiring term of 2 weeks, and the seminar is ended by the notification.

Where a user having purchased any process IP desires any of various sorts of consulting, the management service supplier 301 accepts an application from a user on a predetermined Web site. The user is free to enter on the Web site and pose what questions are of interest to the user. Incidentally, the application for consulting can be set so as to be allowed for only users who have purchased any process IPs and who are authorized to access the Web site. Regarding the consulting contents, the method in which the user directly inputs the requested contents can be replaced with a method in which the list of treatable consulting contents is displayed on the Web site, and in which the user is left to select the desired consulting contents from within the list.

The management service supplier 301 having received the user's application, transmits that notice of determination for offering consulting which clearly states the contents of the consulting to be performed and a term for performing the consulting, to the user through the network. Thereafter, the management service supplier performs the consulting for the user in accordance with the contents and the term clearly stated in the notice. The management service supplier notifies a consulting end schedule to the user through the network 7 days, for example, before the scheduled consulting period. Further, the management service supplier 301 sends the expiration notice and the consulting period ends.

In addition to the transfer of process IPs, the system also provides for potential licensees and current licensees to make better use of the process IPs made available through the present invention. For instance, the licensor of process IPs has numerous experts in transfer and integration of technology. In one embodiment, these expert teams include engineers and/or technicians with detailed knowledge in unit processes, process integration, failure analysis, device evaluation, reliability and yield management that are all vital in terms of semiconductor manufacturing. Such an advisory service can benefit a potential licensee in selecting process IPs most appropriate to their current business and future goals.

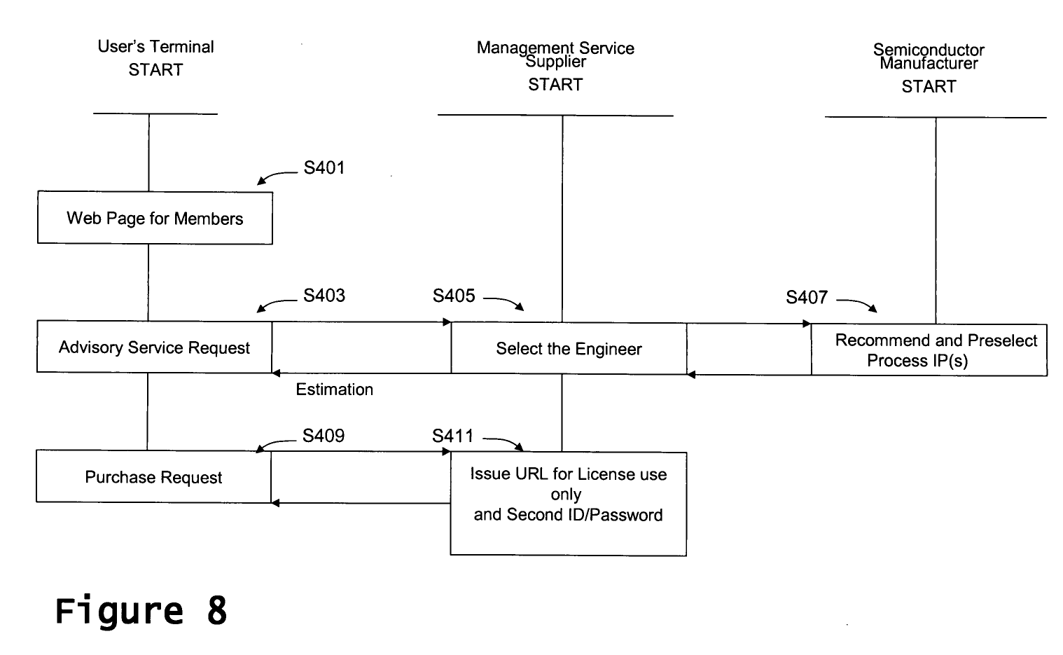

FIG. 8 is an exemplary flowchart describing a process through which a potential licensee can receive advisory services 207 from a process IP owner. The example starts when the user is browsing the web page for members S401 and makes the request for advisory services related to assist the user in selecting process IPs relevant to their business S403. This request is sent to the management service supplier, which selects an agent (e.g., engineer) S405 to assist the user. In this particular embodiment, the engineer is selected from a semiconductor manufacturer, and this engineer selects relevant process IPs for the user S407, and sends these results back to the management service supplier, who estimates the price of the selected Process IPs and sends this estimated cost to the user. The user then makes a request for purchase S409, after which the management service supplier issues a URL for a license agreement accessible using a second ID and second password S411.

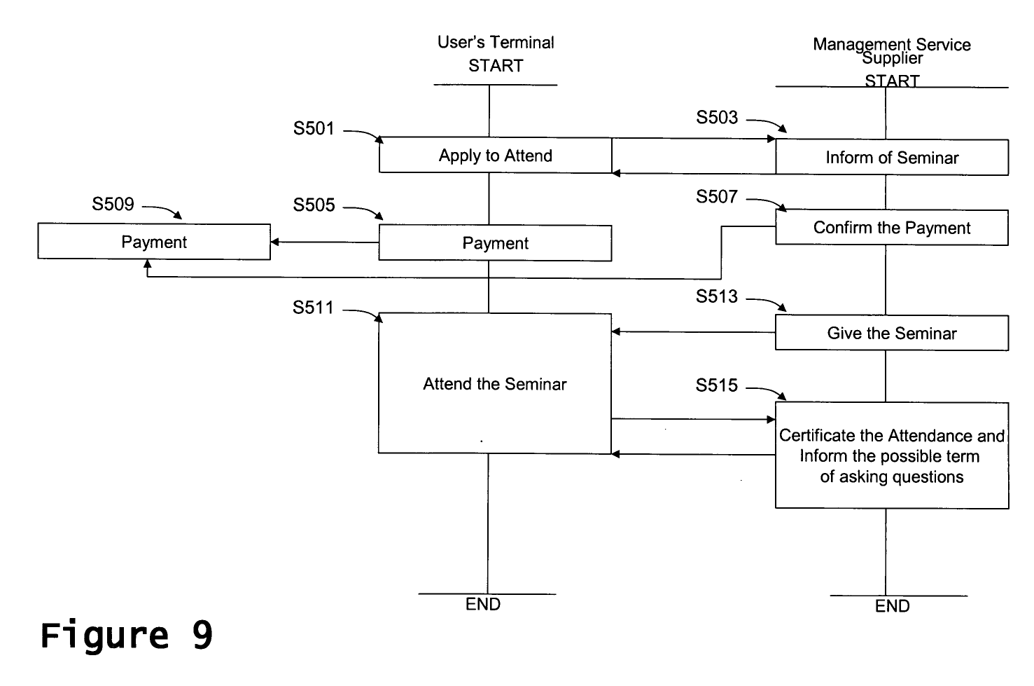

FIG. 9 is an exemplary embodiment of supplemental educational services provided by a Process IP owner to a potential or a current licensee of process IPs. In the particular example of FIG. 9, the educational device used is a seminar, the seminar being either posted online or posted at, for instance, a convention center. In the example, the user applies to attend a seminar S501. The management service supplier informs that the seminar is still available for the user to attend S503. The user then sends payment S505 to a bank S507 and this payment is confirmed by the management service supplier S507. The user then attends the seminar S511 which is given by the management service supplier or an affiliated organization S513. The management service supplier then issues a certificate of attendance to a user and notifies a user of a certain time period in which additional questions can be asked for no additional charge S515.

In addition to the advisory services to guide potential licensees, the present invention also incorporates an integration consulting service, to enable licensees to quickly and effectively integrate process IPs into their business. More efficient technology transfer enables these licensees to better realize the inherent advantages of the new process IPs.

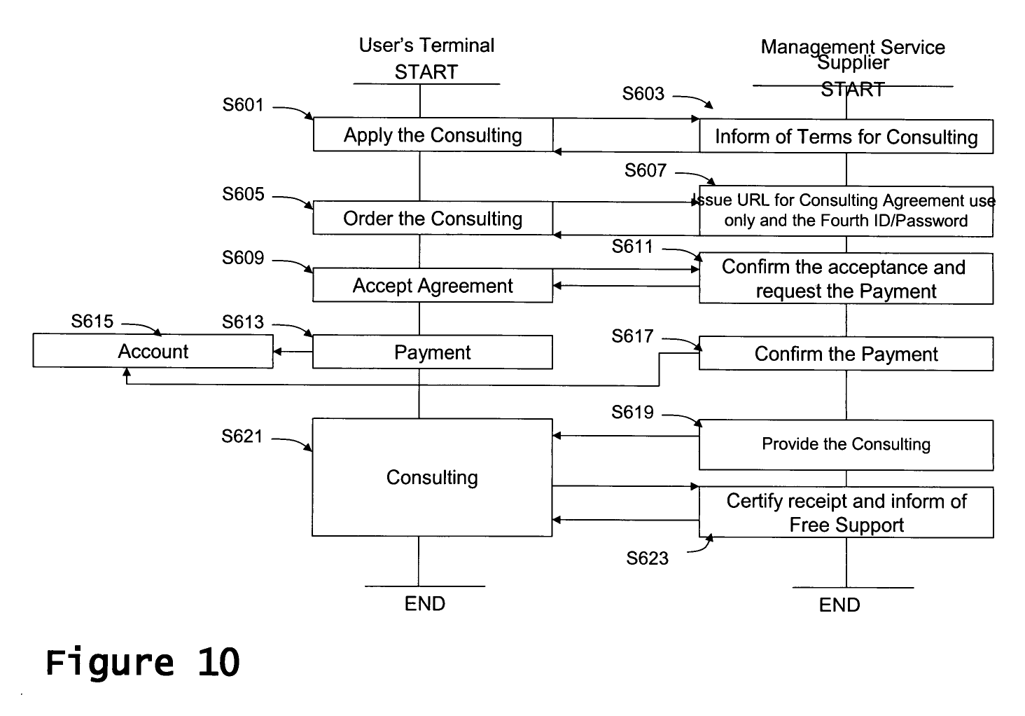

FIG. 10 is an exemplary flow chart describing the provision of integration consulting services by a licensor to a licensee of a process IP. In particular, the example describes integration consulting provided in addition to or in lieu of supplemental information including know-how related to process IPs purchased by the licensee. First, a licensee applies for integration consulting S601 and the licensor informs the licensee of the terms of consulting S603. The terms of consulting include information typically associated with a service contract, including but not limited to estimates of cost, duration, and available services. In one embodiment, the terms are created in accordance with customer (licensee) information such as the process IPs purchased and existing process technology. If the licensee maintains interest in the consulting, integration consulting services are ordered S605 and the licensor sends the licensee a URL for accessing a consulting agreement and an ID and password combination for accessing the agreement S607. Upon the licensee's accepting of the agreement S609, the licensor confirms and requests payment according to the accepted agreement S611. Next, the licensee sends a payment S613 to an account S615, which is confirmed by the licensor S617. The licensor then provides the consulting S619 itself or using another party capable of providing the consulting to the licensee S621. Upon completion of the consulting, the licensor confirms the completion of the services according to the agreement S623 and informs the licensee of any available additional free support. Further, the licensor optionally provides a report describing the contents of the consulting to the licensee. The report is provided to the licensee at the conclusion of the consulting or, optionally, during the consulting. The contents of the report include, for example, a list of rendered services, evaluations of the licensee's technological or operational readiness, associated costs of services, a budget, a description of future objectives, and action items associated with future objectives or continuing programs.

Alternative embodiments of the present invention provide for the independent provision of consulting services. For example, such an embodiment enables a user to order and receive consulting services without purchasing rights to a process IP. Accordingly, as a prospective licensee is able to receive such integration services separate from purchasing or committing to purchase a process IP, the potential licensee can make a more informed decision regarding the appropriate process IP or process IPs from which to choose. Additionally, a licensor is thus able to generate service-based revenue independent from granting rights to its process IPs.

Another embodiment of the present invention incorporates a corporate membership program, and offers specific services targeted and tailored for these corporate members. These services can include enhanced access to process IPs via the web site or in physical data medium deliveries containing process IP information and know-how. The services can also include consultation services for potential licensees (advisory services), lectures given by expert teams available to purchasers of process IPs. Additionally, in the case of the semiconductor industry, integration consulting services described above are provided to corporate members for tasks such as converting to CMOS from bipolar processes, moving to more advanced products and introducing new equipment. An expert team can advise a licensee on both the selection of process IPs and integration of these process IPs into the licensees existing process. Yet another embodiment of the invention offers free technical support via the web and on-site services offer far more detailed analysis and provision of solutions to customer problems.

With regard to the services mentioned above, the present invention allows for services (and corresponding licenses, if they exist) to be rendered for a predetermined period of time. Moreover, in alternative embodiments, services such as technical support are incorporated into the licenses corresponding to at least a portion of a licensee's predetermined process technology, such as a Process Module. Additionally, support can be limited with regard to time, allowing a licensee to limit exposure to a support commitment to licensed process technology.

In addition to the above-described embodiments describing the licensing or granting of rights to process IPs, alternative embodiments enable the sale of IP rights and data in addition to, or in lieu of, transferring such process IPs through licensing or similar transactions. The above-described embodiments are thus equipped to accommodate the enablement of such sales via assignment provisions in place of license agreements.

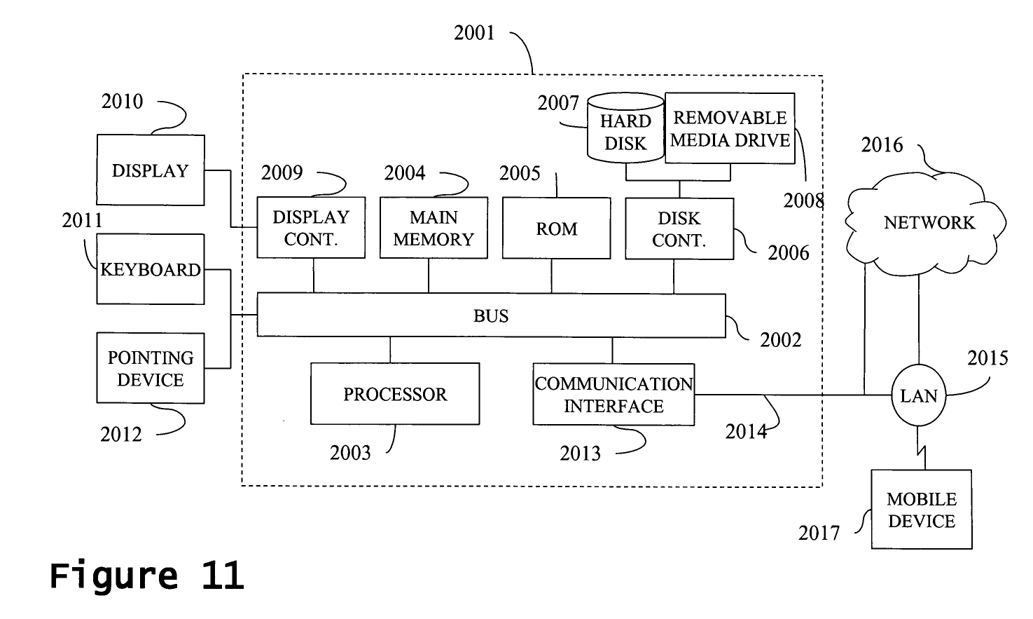

FIG. 11 is a block diagram of a computer system (or server) 2001 upon which an embodiment of the present invention may be implemented. It should be noted however, that the present system need not be based on a personal computer (PC) configuration, but rather a custom processor-based system that does not include the features of a general purpose computer may be used as well. Nevertheless, because the actual hardware configuration used to support the present invention, is not so restricted, an example of PC-based system is now provided. The computer system 2001 includes a bus 2002 or other communication mechanism for communicating information, and a processor 2003 coupled with the bus 2002 for processing the information. The computer system 2001 also includes a main memory 2004, such as a random access memory (RAM) or other dynamic storage device (e.g., dynamic RAM (DRAM), static RAM (SRAM), and synchronous DRAM (SDRAM)), coupled to the bus 2002 for storing information and instructions to be executed by processor 2003. In addition, the main memory 2004 may be used for storing temporary variables or other intermediate information during the execution of instructions by the processor 2003. The computer system 2001 further includes a read only memory (ROM) 2005 or other static storage device (e.g., programmable ROM (PROM), erasable PROM (EPROM), and electrically erasable PROM (EEPROM)) coupled to the bus 2002 for storing static information and instructions for the processor 2003.

The computer system 2001 also includes a disk controller 2006 coupled to the bus 2002 to control one or more storage devices for storing information and instructions, such as a magnetic hard disk 2007, and a removable media drive 2008 (e.g., floppy disk drive, read-only compact disc drive, read/write compact disc drive, compact disc jukebox, tape drive, and removable magneto-optical drive). The storage devices may be added to the computer system 2001 using an appropriate device interface (e.g., small computer system interface (SCSI), integrated device electronics (IDE), enhanced-IDE (E-IDE), direct memory access (DMA), or ultra-DMA).

The computer system 2001 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 2001 may also include a display controller 2009 coupled to the bus 2002 to control a display 2010, such as a cathode ray tube (CRT), for displaying information to a computer user. The computer system includes input devices, such as a keyboard 2011 and a pointing device 2012, for interacting with a computer user and providing information to the processor 2003. The pointing device 2012, for example, may be a mouse, a trackball, or a pointing stick for communicating direction information and command selections to the processor 2003 and for controlling cursor movement on the display 2010. In addition, a printer may provide printed listings of data stored and/or generated by the computer system 2001.

The computer system 2001 performs a portion or all of the processing steps of the invention in response to the processor 2003 executing one or more sequences of one or more instructions contained in a memory, such as the main memory 2004. Such instructions may be read into the main memory 2004 from another computer readable medium, such as a hard disk 2007 or a removable media drive 2008. One or more processors in a multi-processing arrangement may also be employed to execute the sequences of instructions contained in main memory 2004. In alternative embodiments, hard-wired circuitry may be used in place of or in combination with software instructions. Thus, embodiments are not limited to any specific combination of hardware circuitry and software.

As stated above, the computer system 2001 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 2001, for driving a device or devices for implementing the invention, and for enabling the computer system 2001 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 2003 for execution. A computer readable medium may take many forms, including but not limited to, non-volatile media, volatile media, and transmission media. Non-volatile media includes, for example, optical, magnetic disks, and magneto-optical disks, such as the hard disk 2007 or the removable media drive 2008. Volatile media includes dynamic memory, such as the main memory 2004. Transmission media includes coaxial cables, copper wire and fiber optics, including the wires that make up the bus 2002. Transmission media also may also take the form of acoustic or light waves, such as those generated during radio wave and infrared data communications.

Various forms of computer readable media may be involved in carrying out one or more sequences of one or more instructions to processor 2003 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 2001 may receive the data on the telephone line and use an infrared transmitter to convert the data to an infrared signal. An infrared detector coupled to the bus 2002 can receive the data carried in the infrared signal and place the data on the bus 2002. The bus 2002 carries the data to the main memory 2004, from which the processor 2003 retrieves and executes the instructions. The instructions received by the main memory 2004 may optionally be stored on storage device 2007 or 2008 either before or after execution by processor 2003.

The computer system 2001 also includes a communication interface 2013 coupled to the bus 2002. The communication interface 2013 provides a two-way data communication coupling to a network link 2014 that is connected to, for example, a local area network (LAN) 2015, or to another communications network 2016 such as the Internet. For example, the communication interface 2013 may be a network interface card to attach to any packet switched LAN. As another example, the communication interface 2013 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 2013 sends and receives electrical, electromagnetic or optical signals that carry digital data streams representing various types of information.

The network link 2014 typically provides data communication through one or more networks to other data devices. For example, the network link 2014 may provide a connection to another computer through a local network 2015 (e.g., a LAN) or through equipment operated by a service provider, which provides communication services through a communications network 2016. The local network 2014 and the communications network 2016 use, for example, electrical, electromagnetic, or optical signals that carry digital data streams, and the associated physical layer (e.g., CAT 5 cable, coaxial cable, optical fiber, etc). The signals through the various networks and the signals on the network link 2014 and through the communication interface 2013, which carry the digital data to and from the computer system 2001 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 2001 can transmit and receive data, including program code, through the network(s) 2015 and 2016, the network link 2014, and the communication interface 2013. Moreover, the network link 2014 may provide a connection through a LAN 2015 to a mobile device 2017 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A computer-implemented method for granting IP rights on a sub-divided portion of predetermined manufacturing process technology, comprising steps of:
subdividing said predetermined manufacturing process technology, including substeps of
within said predetermined manufacturing process technology, separating an intangible asset from a plurality of process technology data units, and
dividing said plurality of process technology data units into at least one of
a first process technology data unit and a second process technology data unit, and
a first process IP data unit and a second process IP data unit; and
granting IP rights to a third party that requests IP rights to at least one of said first process technology data unit and said first process IP data unit, but not an entirety of said predetermined manufacturing process technology.

2. The method of claim 1, wherein said intangible asset is at least one of
a yield management process, and
a facility management process.

3. The method of claim 2, further comprising:
granting a service license to said third party for said intangible asset.

4. The method of claim 1, wherein said predetermined manufacturing process technology is a proprietary CMOS process.

5. The method of claim 1, wherein said first process technology data unit is at least one of
a shallow trench isolation process,
a gate contact process,
a salicide process,
a metallization process, and
an inner metal dielectric process.

6. The method of claim 1, wherein said first process technology data unit is one of a set of process technology data units that constitute at least one of
a front end of line manufacturing process data unit, and
a back end of line manufacturing process data unit.

7. The method of claim 6, wherein said granting step includes granting IP rights to said set of process technology data units.

8. The method of claim 1, wherein said first process EP data unit is at least one of
a CVD process,
a dry or wet etch process,
a lithography process,
a deposition process, and
a polishing process.

9. The method of claim 1, further comprising another granting step for granting to the third party a remaining portion of IP rights for said entirety of said predetermined manufacturing process technology, said granting step and said another granting step being separate steps in incremental licenses.

10. The method of claim 2, wherein:
said granting step includes offering technical support to said third party for said at least one of said first process technology data unit and said first process IP data unit.

11. The method of claim 10, further comprising:
granting IP rights to said third party for another process technology data unit that is from a different manufacturing process technology than said predetermined manufacturing process technology, wherein
said step of providing technical support includes providing technical support for said another process technology data unit in addition to said at least one of said first process technology data unit and said first process IP data unit.

12. The method of claim 11, wherein said technical support includes integration consulting service offered independently of at least one of a first process technology data unit and a second process technology data unit, and a first process IP data unit and a second process IP data unit.

13. The method of claim 1, further comprising:
sending from a management service supplying mechanism a digital message over a digital communication link to said third party with data representing candidate process technology data units available for transfer of IP rights; and
receiving at said management service supplying mechanism a selection signal that contains information requesting IP rights for said at least one of said first process technology data unit and said first process EP data unit.

14. The method of claim 13, wherein said sending step includes sending said digital message over said digital communication link, at least a portion of which includes the Internet.

15. The method of claim 1, wherein said granting step includes granting:
an ability to access RTL code.

16. The method of claim 1, wherein said granting step includes granting:
a right to make.

17. The method of claim 1+wherein said granting step includes granting:
a right to use.

18. The method of claim 1, wherein said granting step includes granting:
a have made right.

19. The method of claim 1, wherein said granting step includes granting:
a right to sell.

20. The method of claim 1, wherein said granting step includes granting:
a right to import or export.

21. The method of claim 1, wherein said granting step includes defining said IP rights to include a restriction on at least one of:
a predetermined time period;
a predetermined geography;
a predetermined field of use;
a predetermined level of exclusivity; and
an ability to assign or sub-license.

22. The method of claim 1, wherein:
said subdividing step includes subdividing said plurality of process technology data units into said first process IP data unit and said second process IP data unit, and
said first process IP data unit has a complementary data unit which is said second process IP data unit.

23. The method of claim 1, further comprising steps of:
storing in an electronic archive said at least one of said first process technology data unit and said second process technology data unit, and said first process IP data unit and said second process IP data unit.

24. The method of claim 23, wherein said dividing step comprises:
dividing said predetermined manufacturing process technology into said plurality of process technology data units according to at least one of
a process hierarchy parameter, and
a technology information parameter.

25. The method of claim 24, wherein said process hierarchy parameter comprises at least one of:
a full process;
process module set;
a process module; and
a unit process.

26. The method of claim 24, wherein said technology information parameter comprises at least one of:
clean room facility information;
test vehicle information;
design information;
process information;
equipment information;
material information;
device information; and
quality and reliability information.

27. The method of claim 1, wherein said granting step comprises:
proposing a license corresponding to said at least one of said first process technology data unit and said first process IP data unit.

28. The method of claim 27, further comprising:
receiving from said third party a customer identification which grants said third party access to a web site hosted by a management service supplying mechanism that is configured to execute said granting step; and
delivering at least one of documentation and computer code associated with said at least one of said first process technology data unit and said first process IP data unit to which said third party was granted rights.

29. The method of claim 28, wherein said delivering step includes delivering said at least one of documentation and computer code via at least one a computer readable medium and an electronic message send over said communication link.

30. The method of claim 1, further comprising:
offering to said third party a related service that includes at least one of integration, consulting, technical support, and education.

31. The method of claim 30, further comprising:
granting a service license corresponding to said related service.

32. The method of claim 23, further comprising:
receiving a request signal for IP rights to said at least one of said first process technology data unit and said second process technology data unit, and said first process IP data unit and said second process IP data unit; and
matching said request signal with said at least one of said first process technology data unit and said second process technology data unit, and said first process IP data unit and said second process IP data unit stored in said electronic archive.

33. The method of claim 1, wherein said granting step includes proposing a license corresponding to said at least one of said first process technology data unit and said first process IP data unit, wherein said license is at least one of an electronic license and a paper-based license.

34. A computer-implemented method for selling IP on a sub-divided portion of predetermined manufacturing process technology, comprising steps of:
subdividing said predetermined manufacturing process technology, including substeps of
within said predetermined manufacturing process technology, separating an intangible asset from a plurality of process technology data units, and
dividing said plurality of process technology data units into at least one of
a first process technology data unit and a second process technology data unit, and
a first process IP data unit and a second process IP data unit; and
selling IP to a third party that requests IP to at least one of said first process technology data unit and said first process IP data unit, but not an entirety of said predetermined manufacturing process technology.

35. A computer-implemented system for transferring IP rights to a sub-divided portion of a predetermined manufacturing process technology, comprising:
a first electronic archive configured to hold therein
a first process technology data unit and a second process technology data unit, and
a first process IP data unit and a second process IP data unit;
a second electronic archive configured to hold therein a customer identification data that is retrieved when a third party attempts to access said first electronic archive, said customer identification data including identification data and an indication of access rights obtained by said third party for granting access to said first electronic archive;
a management service supplier mechanism configured to serve web pages to a computer of said third party, said web pages include
an access and verification web page that permits access to said third party if data is entered that matches said customer identification data held in said second electronic archive, and
a process IP web page that presents for selection at least a subset of said first process technology data unit and second process technology data unit, and said first process EP data unit and said second process IP data unit; and
a data delivery mechanism that is configured to send over a digital communication link to said third party said sub-divided portion of said predetermined manufacturing process technology selected by said third party.

36. The system of claim 35, wherein:
said web pages further include a licensing web page that presents to said third party a license to be executed by said third party prior to said third party being granted access to said first electronic archive.

37. The system of claim 35, wherein:
said web pages further include a services web page that presents to said third party an option for contracting to obtain at least one of technical support services, consulting services, and educational services, in addition to said obtaining IP rights for said sub-divided portion of a predetermined manufacturing process technology.

38. A computer-implemented method for granting IP rights on a sub-divided portion of predetermined manufacturing process technology, comprising steps of:
subdividing said predetermined manufacturing process technology, including substeps of
within said predetermined manufacturing process technology, separating an intangible asset from a plurality of process technology data units, and
dividing said plurality of process technology data units into at least one of
a first process technology data unit and a second process technology data unit, and
a first process IP data unit and a second process IP data unit; and
offering a service related to integration of at least a portion of said predetermined manufacturing process technology.

39. A computer-implemented system for receiving IP rights to a sub-divided portion of a predetermined manufacturing process technology, comprising:
a network interface configured to exchange digital messages with a management service supplier computer over a network;
a browser configured to display web pages served by said management service supplier computer;
an input mechanism configured for a user to enter customer identification data and select items presented on said web pages; and
a processor configured to execute computer readable instructions that implement
a messaging mechanism configured to insert said customer identification data into fields presented in said web pages so as to enable said user to gain access to a first electronic archive of said management service supplier computer, said first electronic archive configured to hold therein
a first process technology data unit and a second process technology data unit, and
a first process IP data unit and a second process IP data unit, wherein
said management service supplier computer includes a second electronic archive configured to hold therein said customer identification data that is retrieved when said messaging mechanism sends a digital message that includes said customer identification data;
a management service supplier mechanism configured to serve web pages to a computer of said third party, said web pages include
an access and verification web page that permits access to said customer identification data included in said digital message matches said customer identification data held in said second electronic archive, and
a process IP web page that presents for selection on said browser at least a subset of said first process technology data unit and second process technology data unit, and said first process IP data unit and said second process IP data unit.

40. The computer-implemented system of claim 39, wherein:
said messaging mechanism is configured to prepare a selection message for said process IP message receive said sub-divided portion of said predetermined manufacturing process technology selected by said selection message.

41. A computer program product that contains computer readable instructions for execution on a computer-implemented system for transferring IP rights to a sub-divided portion of a predetermined manufacturing process technology, said computer program product comprising:
means for subdividing said predetermined manufacturing process technology, including
means for separating an intangible asset from a plurality of process technology data units within said predetermined manufacturing process technology, and
means for dividing said plurality of process technology data units into at least one of
a first process technology data unit and a second process technology data unit, and
a first process IP data unit and a second process IP data unit; and
means for conveying IP rights to a third party that requests IP rights to at least one of said first process technology data unit and said first process IP data unit, but not an entirety of said predetermined manufacturing process technology.
